(19) United States
(12) Patent Application Publication
(10) Pub. No.: US 2008/0023564 A1
(43) Pub. Date: Jan. 31, 2008

(54) Method And Apparatus For Centrally Controlling A Hybrid Furnace, Heater, And Boiler System Installation

(76) Inventor: Robert Charles Hall, Brown Deer, WI (US)

Correspondence Address: Robert Charles Hall, Jr., 9173 N Pearlette Lane, Brown Deer, WI, 53223, US

(21) Appl. No.: 11/739,763

(22) Filed: Apr. 25, 2007

Related U.S. Application Data
(60) Provisional application No. 60/795,817, filed on Apr. 28, 2006.

(51) Int. Cl. F24D 12/02; B60H 1/00

(52) U.S. Cl. 237/12; 237/2 A

(57) ABSTRACT

A method and apparatus for centrally controlling a hybrid furnace, heater, and boiler system installation which increases the operational cost efficiency of the hybrid installation by computing the operational efficiency and fuel costs of the individual furnace(s), heater(s), and boiler(s) and signaling the most advantageous choice. The apparatus may further embody thermostatic control functions.

### CROSS-REFERENCE TO RELATED APPLICATIONS

This application claims the benefit of PPA 0795817, filed Apr. 28, 2006 by the present inventor.

### BACKGROUND OF THE INVENTION

This application relates to electronic controls for furnaces, heaters, and boilers.

### OBJECTS AND ADVANTAGES OF THE INVENTIONS

Traditionally, upon the design and commissioning of a facility, whether industrial, commercial or residential, a single source of power is chosen to be used for the generation of hot air, steam, and/or hot water. The chosen source of power has been selected taking into account the relative merits of predicted cost, efficiency, and convenience. More recently, facilities have been designed and commissioned with hybrid systems, or multiple independent systems, utilizing diverse energy sources in order to take advantage of changes in relative operational costs based upon the changing prices of the energy. However, the emergence of dynamic pricing of some energy sources; i.e. off-peak pricing, time-of-use metering, and real-time pricing; has made the calculation of the relative merits of the energy sources dependent upon the time of the day, week, month, season, etc. Indeed, the possibility of real-time pricing of energy allows for the cost of some energy sources to change many times per day in unpredictable ways. Such dynamic pricing of energy has made it efficient or desirable to install multiple systems within facilities for the generation of heat, steam and/or hot water utilizing diverse energy sources and switching between those multiple systems or energy sources in order to affect lower operating costs. However, it has been inconvenient to track the changing costs of the energy, re-calculate the relative costs between the multiple systems available, chose the most cost-efficient system, and activate the chosen system while de-activating the remaining systems. A method and apparatus for the automatic control of these hybrid systems utilizing diverse energy sources, taking dynamic costing of energy into account, has not been available and is directly addressed by the invention.

There are many different fuels and types of furnaces, heaters, and boilers that may be utilized in hybrid installations. Furnaces, heaters, and boilers are often fueled by electricity, natural gas, propane, coal, oil, wood, or, even, solar radiation. Such diversity of possible energy sources leads to two immediate problems in comparing the relative cost efficiencies of furnace/heater/boiler installations: fuels are delivered and priced in different units not directly comparable with each other; and, different furnaces, heaters, and boilers utilizing different fuels may be vastly divergent in their efficiency at extracting and delivering heat from the fuel. For example, electricity is commonly billed in units of kilowatt-hours, natural gas is commonly billed in units of therms, oil priced by the gallon, and coal priced by the ton. The method of the invention includes a mathematical equation allowing the relative costs of the furnace/heater/boiler systems to take into account the given units of measurement for each fuel utilized and the heat-extraction efficiency of the systems.

Another aspect of the cost-efficiency equation embodied in the invention is temperature dependency. Certain kinds of furnaces, heaters, and/or boilers, or their specific installations, may have their efficiency at converting the fuel to heat affected by the temperature at which the equipment is operating. An example of this temperature-dependent efficiency is an electrically-fueled heat pump system, which quotes efficiency in a measurement called Coefficient of Performance. A heat pump operating in heat mode removes available heat from the outside environment, concentrates it, moves it to the controlled indoors environment, and releases it. However, the efficiency of this process is very dependent upon the temperature of the outside environment. The invention is capable of taking the temperature-dependence of the system into account when calculating the cost-efficiency of the hybrid installation.

An example of an installation where the invention would be advantageous is a residential home with a natural gas-fired forced-air furnace, as well as an electrically-fueled heat pump. Under normal circumstances, the natural gas has a time-fixed price, but electricity may be obtained under time-sensitive conditions; i.e. time-of-use metering. During electrical peak usage periods, the electrical utility charges higher prices for delivered power, but offers lower pricing during non-peak hours. Utilizing the invention, the residence would be able to heat with natural gas during peak hours and switch automatically to the electrically-fueled heat pump during non-peak hours, while assuring that the temperature-dependent efficiency of the heat pump is taken into account. This arrangement would allow the residence to be heated with maximized operational cost-efficiency.

### SUMMARY

What is provided is a control device for facilities with multiple furnace, heater, and/or boiler systems. The control device comprises a processing unit-based circuit to calculate the relative operational costs of multiple furnace/heater/boiler systems in real-time, activate the choice of most cost-efficient system, and de-activate the remaining system(s).

What is also provided is a thermostatic control device for facilities with multiple furnace/heater/boiler systems. The thermostatic control device comprises a microprocessor-based circuit to calculate the relative operational costs of multiple furnace/heater/boiler systems in real-time and provide thermostatic control of the most cost-efficient system chosen.

What is also provided is a control device for facilities that have heating system(s) that has its operational efficiency variably dependent upon environment temperature.

What is also provided is a control device for facilities that have heating system(s) that has its operational efficiency variably dependent upon available solar radiation.

What is also provided is a method of calculating the relative operational costs of multiple furnace, heater, and boiler systems automatically in real-time for the purpose of choosing the most cost-efficient system.

### OPERATION

The core operation of the invention is to signal active/non-active status for multiple furnaces, heaters, and/or boilers installed within a facility based upon its calculation of operational cost efficiency for each of the available furnace, heater, and/or boiler systems. The invention apparatus includes circuitry for each installed furnace, heater, or boiler system, which allows each system to be activated or de-activated.

The invention apparatus would be configured for the unit of measurement for the fuel of each system. The invention apparatus would also be configured for the efficiency rating of each system that is not dependent upon environmental temperature or available solar radiation. The invention apparatus may be configured for any fixed time schedules for fuel cost or preference of operation choice of the systems. The invention may also be configured with the period of time between successive iterations of the calculation and comparison of the Operational Cost Efficiency of the heating systems.

The Operational Cost Efficiency is calculated for each furnace, heater, or boiler system based upon fixed configuration and variable input data. The variable data input to the apparatus could include the current time/date, the current environmental (outdoors) temperature, available solar radiation, and the current cost of fuel for each available system. The invention method for calculating the operational efficiency of each system is as follows:

Operational Cost Efficiency=System Operational Rating/(Fuel Cost*Fuel Correction Factor)

The System Operational Rating may be fixed or variable depending upon the system(s) being controlled and the invention embodiment. The invention embodiment may include circuitry for measuring the uncontrolled (outdoors) environment temperature in order to calculate the System Operational Rating, or the System Operational Rating for the systems may be fixed. For example, a gas-fuel furnace may have a fixed System Operational Rating, such as its Annual Fuel Utilization Efficiency (AFUE) number; an electric-fuel heat pump may have a System Operational Rating that is dependent upon the current outdoors environmental temperature; a solar collector may have a System Operational Rating that is dependent upon the available solar radiation and the current outdoors temperature. The variable System Operational Rating may vary gradually with temperature and be represented by a mathematical equation or may change abruptly between two constants at a specific temperature; the specifics of the representation of the variable System Operational Ratings is dependent upon the needs of a specific embodiment.

The Fuel Cost for each controlled system could be input to the invention as fixed, scheduled, or real-time variable. If the Fuel Cost doesn't change often, it could be configured fixed. If the Fuel Cost changes based upon a predictable schedule, such as off-peak pricing, it could be entered as a schedule. If the Fuel-Cost changes unpredictably in real-time, price information can be input to the apparatus in real-time from an outside data connection.

The Fuel Correction Factor is necessary in order to allow direct comparison between different heating systems utilizing different measurement units for fuel. For example, electricity is normally priced in kilowatt-hours, while natural gas is priced based upon therms (100,000 BTUs). An embodiment of the invention would assume a standard unit of fuel cost used for its Operational Cost Efficiency calculation and utilize the Fuel Correction Factor to adjust non-standard Fuel Cost units in order to allow an accurate comparison. As an example, an embodiment of the invention may assume Fuel Cost units to be Dollars per Therm (100,000 BTUs); any controlled system that has its Fuel Cost provided in Dollars per Therm would have a Fuel Correction Factor=1, while any other systems with different Fuel Cost units would have an accurate Fuel Correction Factor configured for that fuel type that allows direct comparison with Dollars per Therm.

Following completion of each iteration of calculating the Operational Cost Efficiency of all systems being controlled, the invention makes a comparison of all of the calculation results and chooses the system with the highest Operational Cost Efficiency. The invention apparatus activates, through its circuitry, the favored heating system, while de-activating the remaining heating system or systems.

Optionally, the invention may also incorporate a thermostatic function (well-known in prior art) for the control of the furnace, heater, and/or boiler systems. Such an embodiment of the invention would allow for the complete operational control of a hybrid furnace/heater/boiler installation without the necessity of additional external thermostatic control(s). In this case, the invention may keep track of the favored heating system internally and only signal it to operate when the thermostatic function determines that operation is required.

### BRIEF DESCRIPTION OF THE DRAWINGS

FIG. 1 is an exemplary embodiment of the invention apparatus as described in claim 5.

FIG. 2 is an alternate exemplary embodiment of the invention apparatus as described in claim 6.

FIG. 3 is an alternate exemplary embodiment of the invention apparatus as described in claim 7.

FIG. 4 is an alternate exemplary embodiment of the invention apparatus as described in claim 8.

FIG. 5 is an alternate exemplary embodiment of the invention apparatus as described in claim 9.

FIG. 6 is an alternate exemplary embodiment of the invention apparatus as described in claim 10.

FIG. 7 is an alternate exemplary embodiment of the invention apparatus as described in claim 11.

FIG. 8 is an alternate exemplary embodiment of the invention apparatus as described in claim 12.

FIG. 9 is an alternate exemplary embodiment of the invention apparatus as described in claim 13.

FIG. 10 is an alternate exemplary embodiment of the invention apparatus as described in claim 14.

FIG. 11 is an alternate exemplary embodiment of the invention apparatus as described in claim 15.

FIG. 12 is an alternate exemplary embodiment of the invention apparatus as described in claim 16.

FIG. 13 is an alternate exemplary embodiment of the invention apparatus as described in claim 17.

FIG. 14 is an alternate exemplary embodiment of the invention apparatus as described in claim 18.

FIG. 15 is an alternate exemplary embodiment of the invention apparatus as described in claim 19.

FIG. 16 is an alternate exemplary embodiment of the invention apparatus as described in claim 20.

FIG. 17 is an exemplary block diagram of a hybrid furnace installation utilizing the invention and a single, shared external thermostat.

FIG. 18 is an exemplary block diagram of a hybrid furnace installation utilizing the invention and multiple external thermostats.

FIG. 19 is an exemplary block diagram of a hybrid furnace installation utilizing the invention with integrated thermostat function.

FIG. 20 is an exemplary block diagram of a hybrid boiler system utilizing the invention with integrated light sensor.

### DETAILED DESCRIPTION OF PREFERED AND EXEMPLARY EMBODIMENTS

Before describing in detail the particular invention apparatus and method, it should be observed that the invention includes, but is not limited to, a novel structural combination of conventional data/signal processing components and communications circuits, and not in the particular detailed configurations thereof. Accordingly, the structure, methods, functions, control and arrangement of conventional components and circuits have, for the most part, been illustrated in the drawings by readily understandable block representations and schematic diagrams, in order to not obscure the disclosure with structural details which will be readily apparent to those skilled in the art, having the benefit of the description herein. Further, the invention is not limited to the particular embodiments depicted in the exemplary diagrams, but should be construed in accordance with the language of the claims.

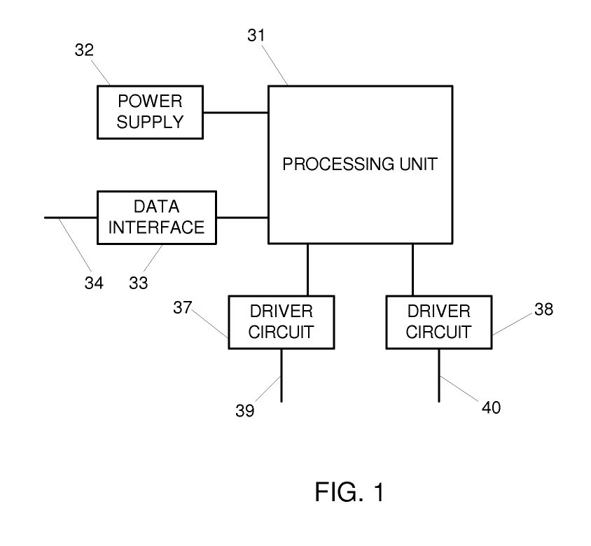

Referring to FIG. 1, a controller Apparatus for the Central Control of Hybrid Furnace, Heater, and Boiler System Installations is depicted. Processing unit 31 is the core component of the Apparatus and may contain combinations of instructional memory, data memory, Method algorithm instructions and peripheral circuitry, as necessary. There are many microprocessors known in the art that could be utilized as the embodiment of processing unit 31. The Apparatus is provided required operational power by power supply 32, which is connected effectively to all of the components of the Apparatus which require electrical current. Power supply 32 would likely consist of an electrochemical cell or AC power transformer and any required circuitry for conditioning the power input. Processing unit 31 is able to communicate with external sources of data through data interface circuit 33 via its data connection 34. Data interface circuit 33 and data connection 34 may implement a human-to-machine interface, consisting of input and output devices such as switches and display, or may implement a machine-to-machine interface, consisting of any particular communications protocol, such as RS-232, Ethernet, or IEEE802.11, in either wired or wireless manners, or may implement both human- and machine-to-machine interfaces. It is expected that data interface circuit 33 and data connection 34 would be utilized by the Apparatus for the purpose of obtaining real-time fuel pricing information, as well as for monitoring and configuration of operational parameters of the control functions of the Apparatus, either remotely or locally. Processing unit 31 is connected to a plurality of driver circuits 37 and 38, with their respective driver connections 39 and 40. FIG. 1 depicts quantity two each of driver circuits 37 and 38, and their driver connections 39 and 40; however, the embodiment may include any number of like driver circuits and driver connections. Driver circuits 37 and 38 function to translate control signals generated by processing unit 31 specifying which of the furnace/heater/boiler systems being controlled should be active and inactive into signals that are compatible with the furnace/boiler systems. Driver circuits 37 and 38 may, for example, utilize electromechanical relays or solid-state transistors to provide simple ON/OFF switching of current-loop control of the furnace/heater/boiler systems, though other circuitry may be embodied. Driver connections 39 and 40 effectively interface the Apparatus to the installed furnace/heater/boiler systems and may be wired or wireless.

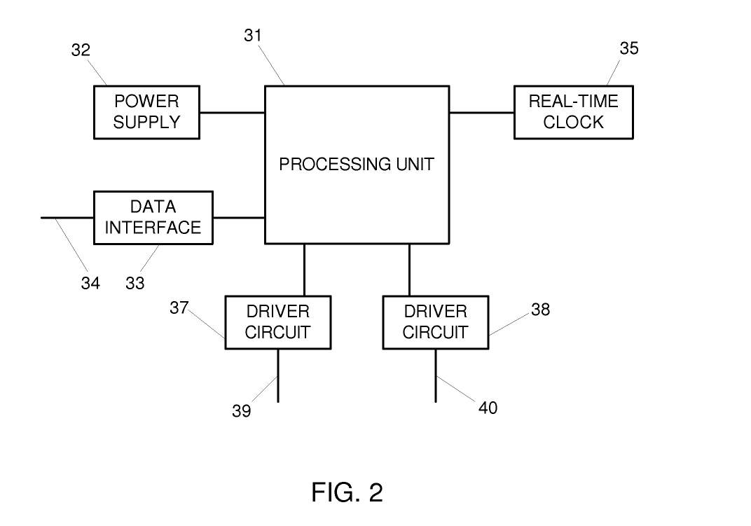

Referring to FIG. 2, an alternate embodiment of the controller Apparatus for the Central Control of Hybrid Furnace, Heater, and Boiler System Installations is depicted. The depicted embodiment adds to the previously referenced embodiment a real-time clock 35 connected to processing unit 31 in order to correctly correlate time-dependent functions and algorithms. Real-time clock 35 would be capable of accurately tracking and communicating to processing unit 31 the current time in hours, minutes, seconds, day of week, date, month, and, perhaps, year. Processing unit 31 is connected to data interface circuit 33 and data connection 34, which allows for the local and/or remote observation of the current time, date, and other operational parameters, as well as the inputting of specific parameters to be used in the control algorithm, such as the efficiency ratings of the heating equipment to be controlled or the fixed time periods for on- and off-peak energy pricing.

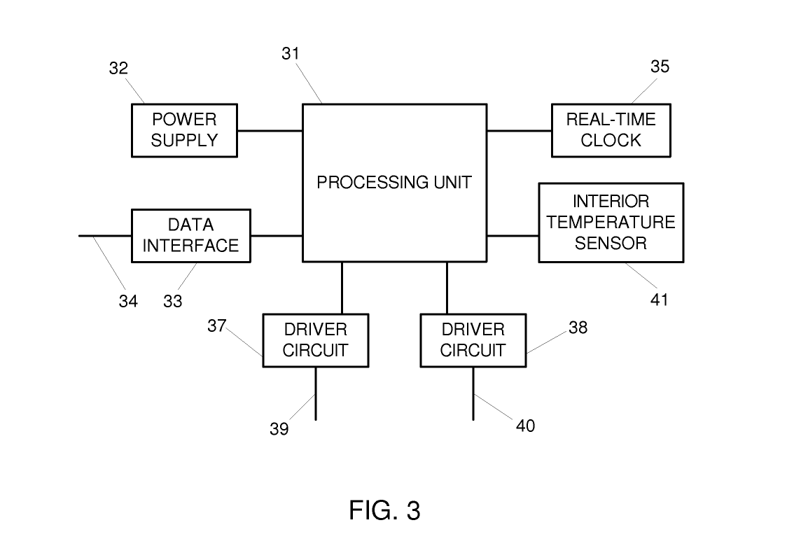

Referring to FIG. 3, an alternate embodiment of the controller Apparatus for the Central Control of Hybrid Furnace, Heater, and Boiler System Installations is depicted. The depicted embodiment includes interior temperature sensor 41, which measures the controlled environment and is connected to processing unit 31 in order to accomplish thermostatic control of the furnace/heater/boiler systems. Thermostatic functions and their control algorithms, which may be time-dependent, are known through prior art. Processing unit 31 is connected to data interface circuit 33 and data connection 34, which allows for the local and/or remote observation of the current temperature setpoint(s) and other operational parameters. The remainder of FIG. 3, including processing unit 31, power supply 32, data interface circuit 33, data connection 34, real-time clock 35, driver circuits 37 and 38, and driver connections 39 and 40 are equivalent to their respective components and descriptions for FIG. 2.

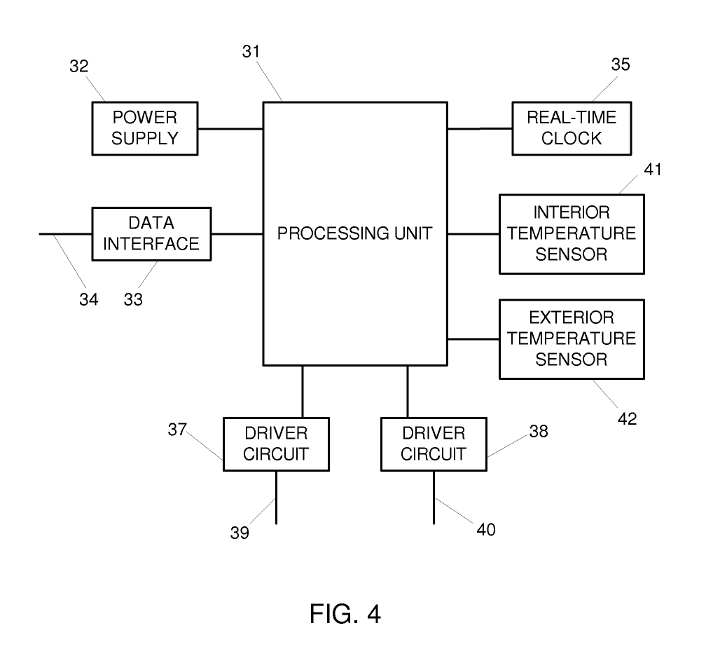

Referring to FIG. 4, an alternate embodiment of the controller Apparatus for the Central Control of Hybrid Furnace, Heater, and Boiler System Installations is depicted. The depicted embodiment includes exterior temperature sensor 42 connected to processing unit 31 for the purpose of measuring the exterior environmental temperature that could affect the operational efficiency of one or more of the controlled heating systems. This embodied controller includes the data and means necessary to dynamically compute the efficiency of one or more of the heating systems based upon the exterior environmental temperature as communicated to processing unit 31 by exterior temperature sensor 42. The remainder of FIG. 4, including processing unit 31, power supply 32, data interface circuit 33, data connection 34, real-time clock 35, driver circuits 37 and 38, and driver connections 39 and 40 are equivalent to their respective components and descriptions for FIG. 3.

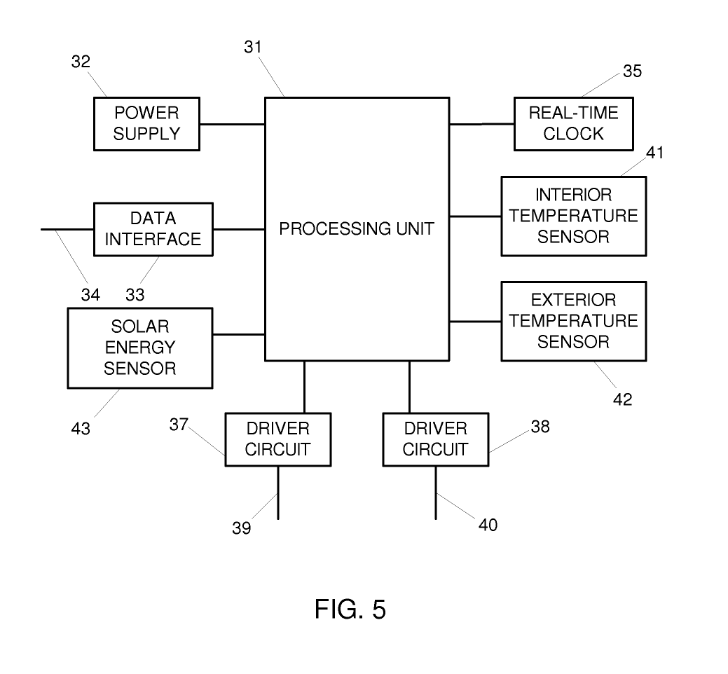

Referring to FIG. 5, another alternate embodiment of the controller Apparatus for the Central Control of Hybrid Furnace, Heater, and Boiler System Installations is depicted. The depicted embodiment includes solar energy sensor 43, which is connected to processing unit 31, in order to measure the available solar radiation. This embodied controller includes the data and means necessary to dynamically compute the efficiency of one or more solar heating systems based upon measured solar energy available as communicated to processing unit 31 by solar energy sensor 43. The remainder of FIG. 5, including processing unit 31, power supply 32, data interface circuit 33, data connection 34, real-time clock 35, driver circuits 37 and 38, driver connections 39 and 40, interior temperature sensor 41, and exterior temperature sensor 42 are equivalent to their respective components and descriptions for FIG. 4.

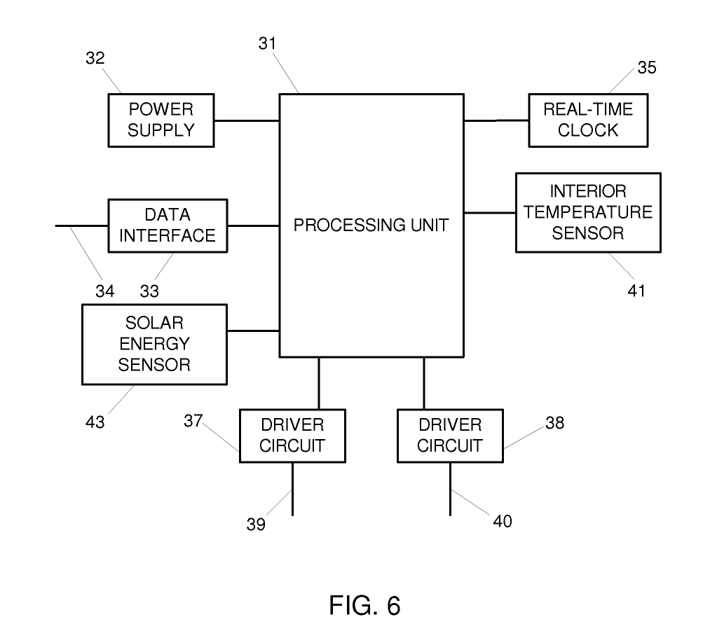

Referring to FIG. 6, another alternate embodiment of the controller Apparatus for the Central Control of Hybrid Furnace, Heater, and Boiler System Installations is depicted. The depicted embodiment includes real-time clock 35, interior temperature sensor 41 with thermostatic control functions, and solar energy sensor 43 with the means necessary for computing the efficiency of one or more solar heating systems, but excludes an exterior temperature sensor. The remainder of FIG. 6, including processing unit 31, power supply 32, data interface circuit 33, data connection 34, driver circuits 37 and 38, and driver connections 39 and 40 are equivalent to their respective components and descriptions for FIG. 1.

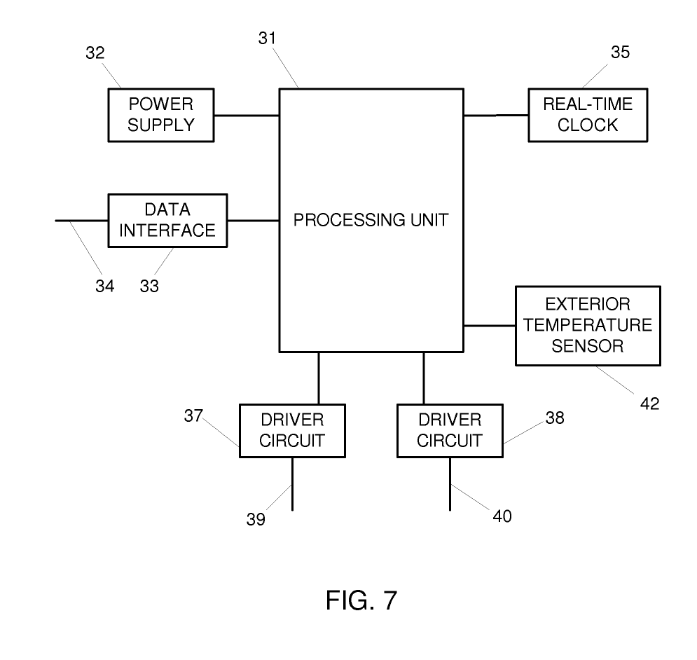

Referring to FIG. 7, another alternate embodiment of the controller Apparatus for the Central Control of Hybrid Furnace, Heater, and Boiler System Installations is depicted. The depicted embodiment includes real-time clock 35 and exterior temperature sensor 42 with the means for computing the efficiency of the heating systems based upon exterior environmental temperature, but excludes an interior temperature sensor, thermostatic control functions, and a solar energy sensor. The remainder of FIG. 7, including processing unit 31, power supply 32, data interface circuit 33, data connection 34, driver circuits 37 and 38, and driver connections 39 and 40 are equivalent to their respective components and descriptions for FIG. 1.

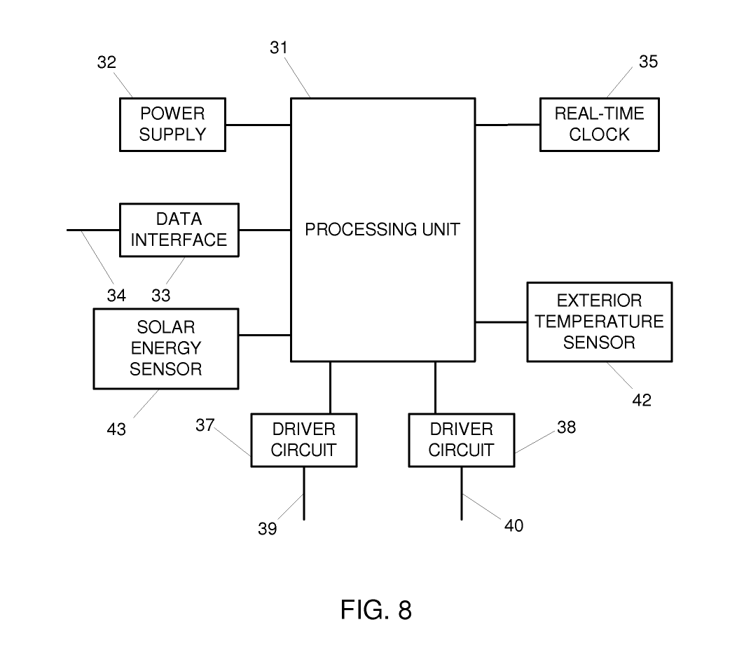

Referring to FIG. 8, another alternate embodiment of the controller Apparatus for the Central Control of Hybrid Furnace, Heater, and Boiler System Installations is depicted. The depicted embodiment includes real-time clock 35, exterior temperature sensor 42 with algorithms for computing the efficiency of the heating systems based upon exterior environmental temperature, and solar energy sensor 43 with the means for computing the efficiency of one or more solar heating systems, but excludes an interior temperature sensor and thermostatic control functions. The remainder of FIG. 8, including processing unit 31, power supply 32, data interface circuit 33, data connection 34, driver circuits 37 and 38, and driver connections 39 and 40 are equivalent to their respective components and descriptions for FIG. 1.

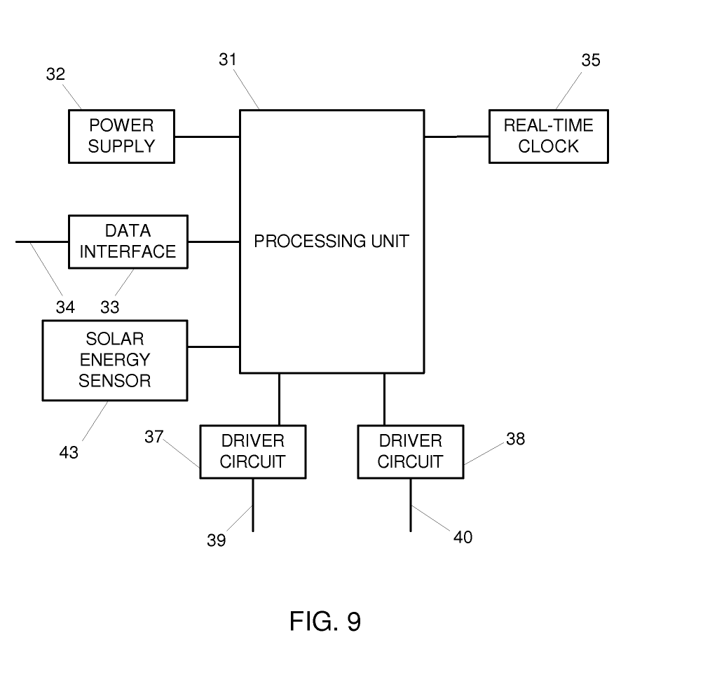

Referring to FIG. 9, another alternate embodiment of the controller Apparatus for the Central Control of Hybrid Furnace, Heater, and Boiler System Installations is depicted. The depicted embodiment includes real-time clock 35 and solar energy sensor 43 with the means for computing the efficiency of one or more solar heating systems, but excludes an interior temperature sensor, thermostatic control functions, and an exterior temperature sensor with its algorithms. The remainder of FIG. 9, including processing unit 31, power supply 32, data interface circuit 33, data connection 34, driver circuits 37 and 38, and driver connections 39 and 40 are equivalent to their respective components and descriptions for FIG. 1.

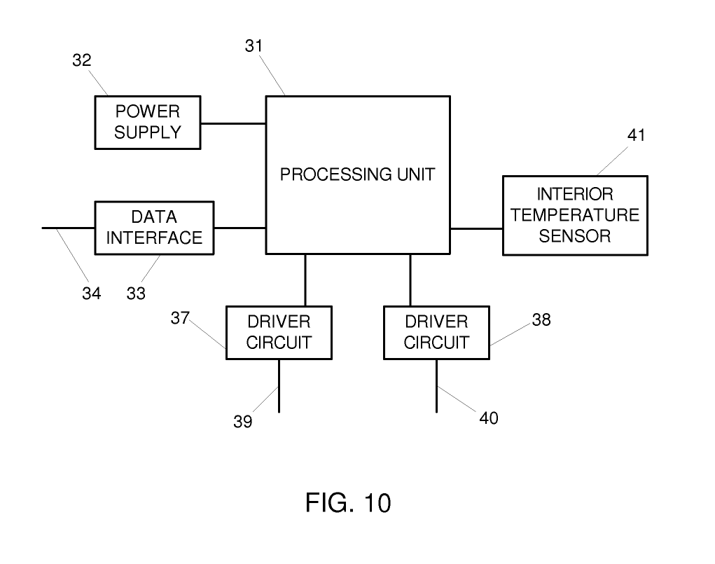

Referring to FIG. 10, an alternate embodiment of the controller Apparatus for the Central Control of Hybrid Furnace, Heater, and Boiler System Installations is depicted. The depicted embodiment includes an interior temperature sensor 41, which measures the controlled environment and is connected to processing unit 31 in order to accomplish thermostatic control of the furnace/heater/boiler systems. Thermostatic functions and their control algorithms are known through prior art. Processing unit 31 is connected to a data interface circuit 33, which allows for the local and/or remote observation of the current temperature setpoint(s) and other operational parameters through data connection 34. The remainder of FIG. 10, including processing unit 31, power supply 32, data interface circuit 33, data connection 34, driver circuits 37 and 38, and driver connections 39 and 40 are equivalent to their respective components and descriptions for FIG. 1.

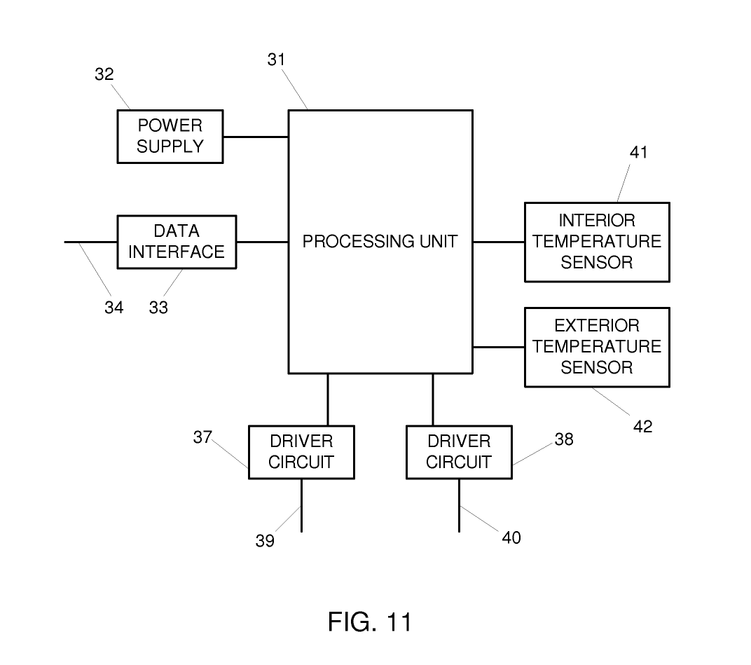

Referring to FIG. 11, another alternate embodiment of the controller Apparatus for the Central Control of Hybrid Furnace, Heater, and Boiler System Installations is depicted. The depicted embodiment includes interior temperature sensor 41, thermostatic control functions, and exterior temperature sensor 42 with the means for computing the efficiency of the heating systems based upon exterior environmental temperature, but excludes a real-time clock and a solar energy sensor. The remainder of FIG. 11, including processing unit 31, power supply 32, data interface circuit 33, data connection 34, driver circuits 37 and 38, and driver connections 39 and 40 are equivalent to their respective components and descriptions for FIG. 1.

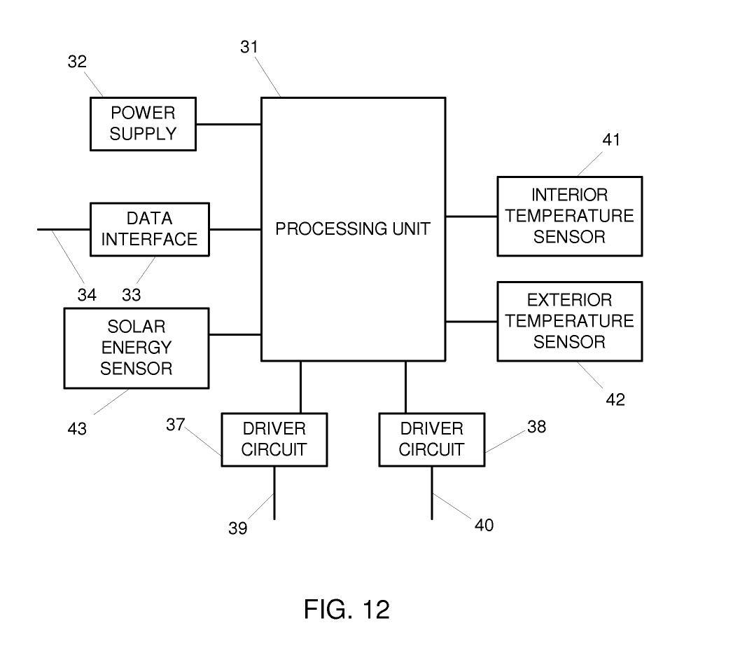

Referring to FIG. 12, another alternate embodiment of the controller Apparatus for the Central Control of Hybrid Furnace, Heater, and Boiler System Installations is depicted. The depicted embodiment includes interior temperature sensor 41 with thermostatic control functions, exterior temperature sensor 42 with the means for computing the efficiency of the heating systems based upon exterior environmental temperature, and solar energy sensor 43 with the means for computing the efficiency of one or more solar heating systems, but excludes a real-time clock. The remainder of FIG. 12, including processing unit 31, power supply 32, data interface circuit 33, data connection 34, driver circuits 37 and 38, and driver connections 39 and 40 are equivalent to their respective components and descriptions for FIG. 1.

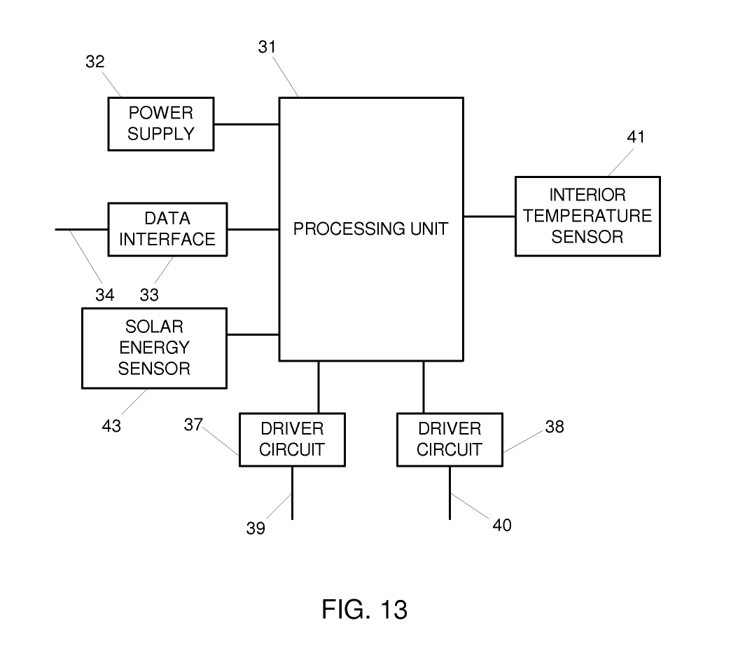

Referring to FIG. 13, another alternate embodiment of the controller Apparatus for the Central Control of Hybrid Furnace, Heater, and Boiler System Installations is depicted. The depicted embodiment includes interior temperature sensor 41, thermostatic control functions, and solar energy sensor 43 with the means for computing the efficiency of one or more solar heating systems, but excludes a real-time clock and an exterior temperature sensor. The remainder of FIG. 13, including processing unit 31, power supply 32, data interface circuit 33, data connection 34, driver circuits 37 and 38, and driver connections 39 and 40 are equivalent to their respective components and descriptions for FIG. 1.

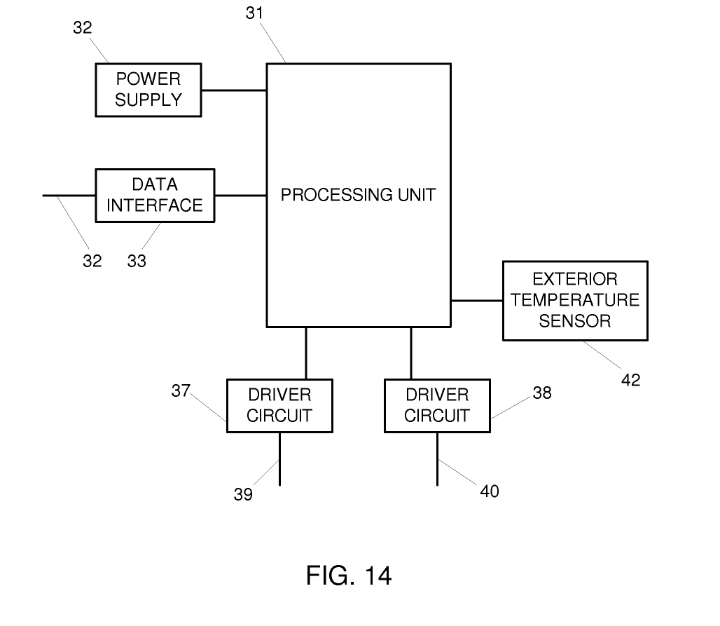

Referring to FIG. 14, an alternate embodiment of the controller Apparatus for the Central Control of Hybrid Furnace, Heater, and Boiler System Installations is depicted. The depicted embodiment includes exterior temperature sensor 42 connected to processing unit 31 for the purpose of measuring the exterior environmental temperature that could affect the operational efficiency of one or more of the controlled heating systems. This embodied controller includes the data and means necessary to dynamically compute the efficiency of one or more of the heating systems based upon the exterior environmental temperature as communicated to processing unit 31 by exterior temperature sensor 42. The remainder of FIG. 14, including processing unit 31, power supply 32, data interface circuit 33, data connection 34, driver circuits 37 and 38, driver connections 39 and 40 are equivalent to their respective components and descriptions for FIG. 1.

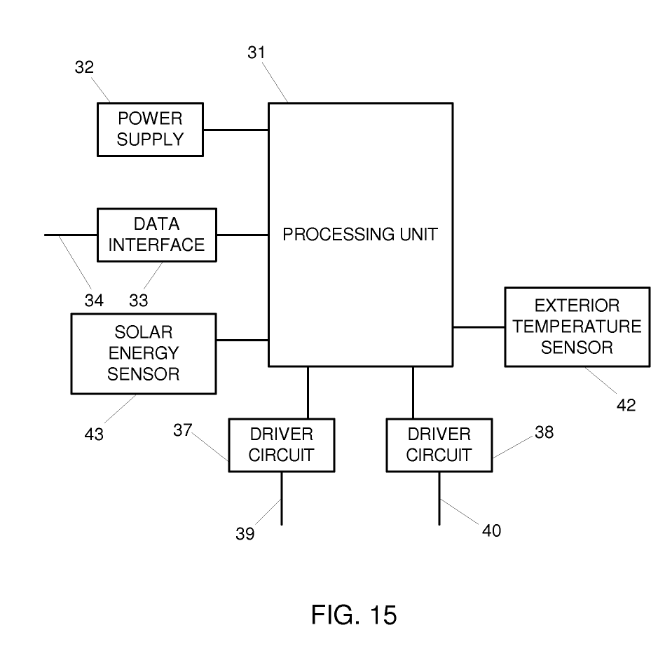

Referring to FIG. 15, another alternate embodiment of the controller Apparatus for the Central Control of Hybrid Furnace, Heater, and Boiler System Installations is depicted. The depicted embodiment includes solar energy sensor 43, which is connected to processing unit 31, in order to measure the available solar radiation. This embodied controller includes the data and means necessary to dynamically compute the efficiency of one or more of the solar heating systems based upon measured solar energy available as communicated to processing unit 31 by solar energy sensor 43. The remainder of FIG. 15, including processing unit 31, power supply 32, data interface circuit 33, data connection 34, driver circuits 37 and 38, driver connections 39 and 40, and exterior temperature sensor 42 are equivalent to their respective components and descriptions for FIG. 14.

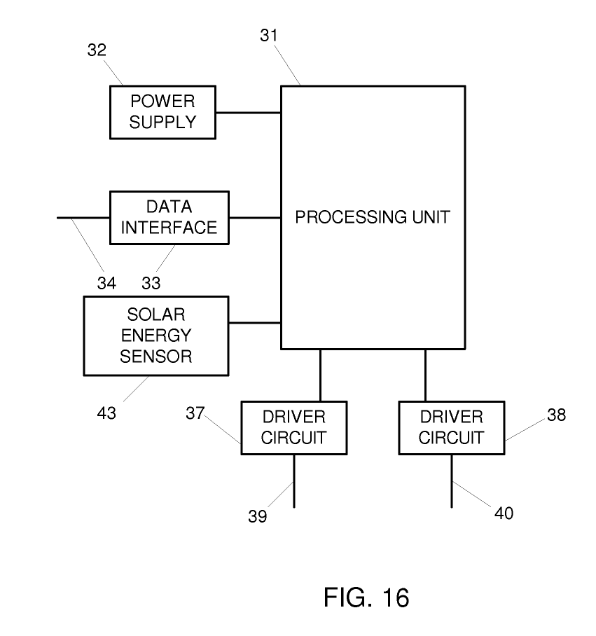

Referring to FIG. 16, another alternate embodiment of the controller Apparatus for the Central Control of Hybrid Furnace, Heater, and Boiler System Installations is depicted. The depicted embodiment includes solar energy sensor 43, which is connected to processing unit 31, in order to measure the available solar radiation. This embodied controller includes the data and means necessary to dynamically compute the efficiency of one or more of the solar heating systems based upon measured solar energy available as communicated to processing unit 31 by solar energy sensor 43. The remainder of FIG. 16, including processing unit 31, power supply 32, data interface circuit 33, data connection 34, driver circuits 37 and 38, and driver connections 39 and 40 are equivalent to their respective components and descriptions for FIG. 1.

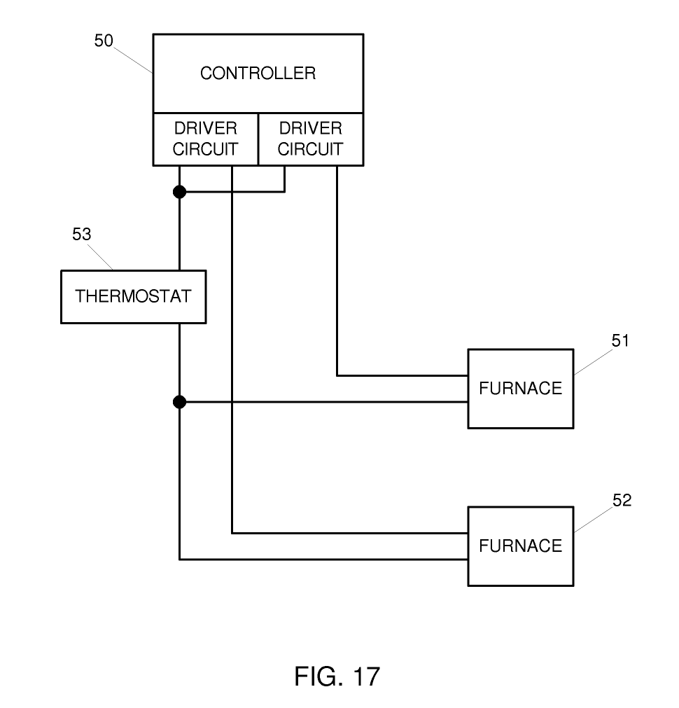

Referring to FIG. 17, an exemplary installation of the invention Apparatus controller as embodied in FIG. 1 is depicted. The depicted installation includes invention Apparatus controller 50 connected to a plurality of furnaces 51 and 52, and thermostat 53. The components depicted are connected in a manner such that controller 50 chooses which one of the plurality of the furnaces is to be actively operational based upon its embodied Method, algorithms, and computations. Thermostat 53 performs its normal functions of controlling chosen furnace 51 or 52 based upon its own embodied method, algorithms, and computations. Controller 50 embodies quantity two driver circuits, one each for furnaces 51 and 52 in the installation, though the plurality of driver circuits embodied in controller 50 and the plurality of furnaces 51 and 52, may be a different quantity. The logical connection of controller 50, furnaces 51 and 52, and thermostat 53 is depicted to be accurate for a physical embodiment that utilizes a current loop control circuit, though other physical control circuits are not excluded.

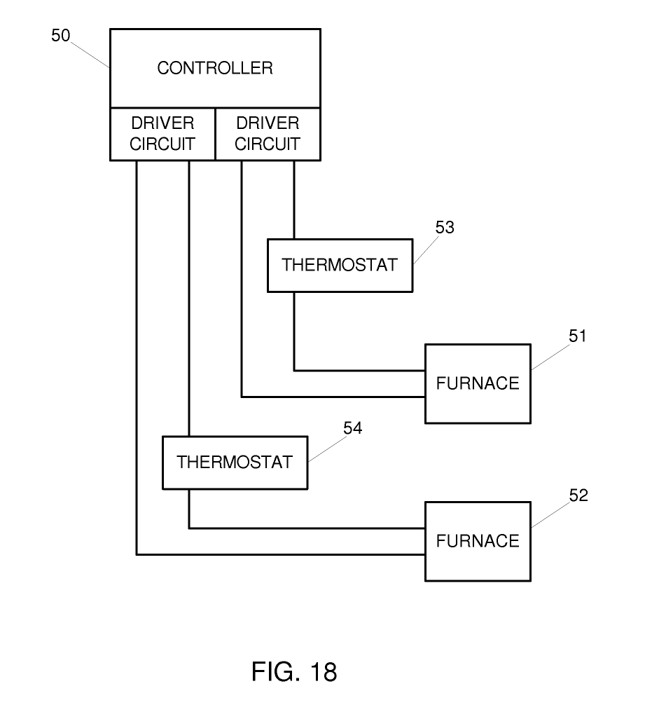

Referring to FIG. 18, an alternate exemplary installation of invention Apparatus controller as embodied in FIG. 1 is depicted. The depicted installation includes invention Apparatus controller 50, a plurality of furnaces 51 and 52, and a plurality of thermostats 53 and 54. The components depicted are connected in a manner such that the controller 50 chooses which one of the plurality of the furnaces is to be actively operational based upon its embodied Method, algorithms, and computations. Thermostats 53 and 54 perform their normal functions of controlling their respective furnace 51 or 52 based upon its own embodied method, algorithms, and computations. Controller 50 embodies quantity two driver circuits, one each for furnaces 51 and 52 in the installation, though the plurality of driver circuits embodied in controller 50, the plurality of furnaces 51 and 52, and the plurality of thermostats 53 and 54, may be a different quantity. The logical connection of controller 50, furnaces 51 and 52, and thermostats 53 and 54 are depicted to be accurate for a physical embodiment that utilizes a current loop control circuit, though other physical control circuits are not excluded.

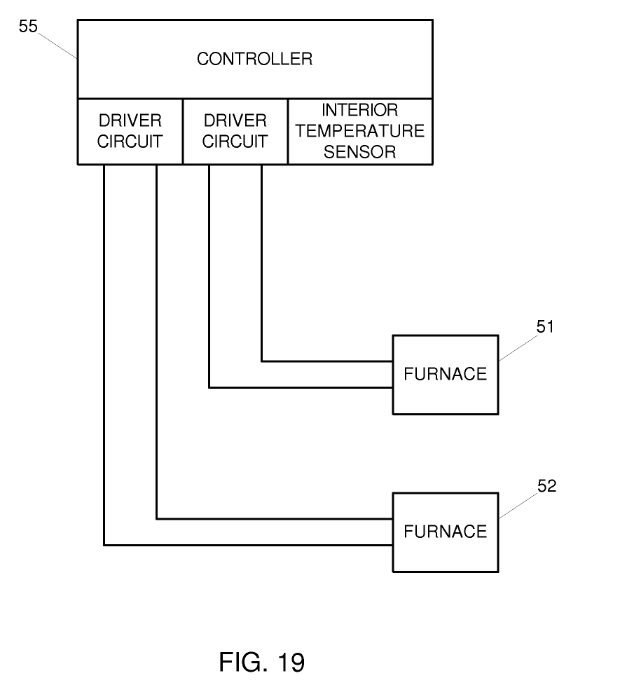

Referring to FIG. 19, another alternate exemplary installation of invention Apparatus controller as embodied in FIG. 10 is depicted. The depicted installation includes controller 55 and a plurality of furnaces 51 and 52. The components depicted are connected in a manner such that controller 55 chooses which one of the plurality of furnaces is to be actively operational based upon its embodied method, algorithms, and computations, as well as performing the thermostatic functions embodied. Controller 55 embodies quantity two driver circuits, one each for furnaces 51 and 52 in the installation, though the plurality of driver circuits embodied in controller 55 and the plurality of furnaces 51 and 52 may be a different quantity. The logical connection of controller 55 and furnaces 51 and 52 are depicted to be accurate for a physical embodiment that utilizes a current loop control circuit, though other physical control circuits are not excluded.

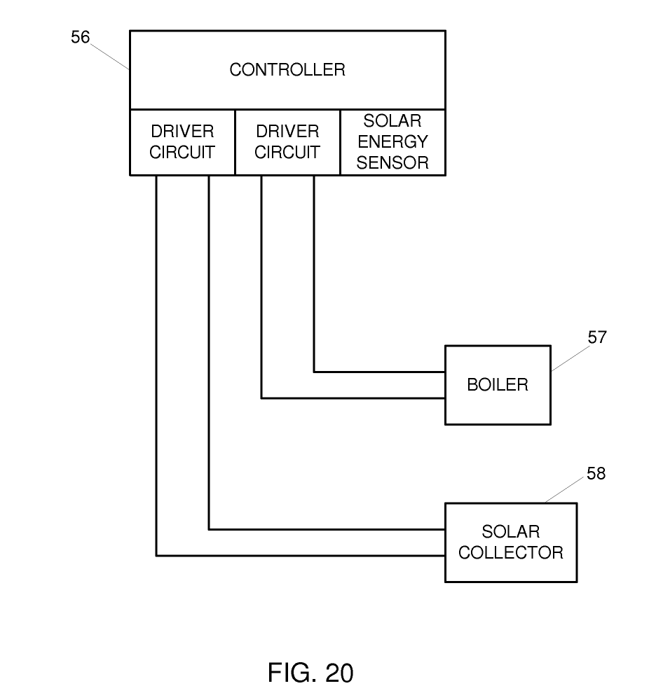

Referring to FIG. 20, another alternate exemplary installation of invention Apparatus controller as embodied in FIG. 16 is depicted. The depicted installation includes controller 56, a boiler 57, and a solar collector 58. The components depicted are connected in a manner such that controller 56 chooses whether boiler 57 or solar collector 58 is to be actively operational based upon its embodied Method, algorithms, and computations. Controller 56 embodies quantity two driver circuits, one each for boiler 57, and solar collector 58, though the plurality of driver circuits embodied in controller 56 and the plurality of controlled systems may be a different quantity. The logical connection of controller 56, boiler 57, and solar collector 58 are depicted to be accurate for a physical embodiment that utilizes a current loop control circuit, though other physical control circuits are not excluded.

While the detailed drawings, specific examples, and particular formulations given describe preferred and exemplary embodiments, they serve the purpose of illustration only. The inventions disclosed are not limited to the specific forms shown. For example, the methods may be performed in any variety of sequence of steps. The hardware and software configurations shown and described may differ depending on the chosen performance characteristics and physical characteristics of the computing and/or communication devices. For example, the type of computing or communication device may differ. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

I claim:

1) A method for centrally controlling a hybrid furnace, heater, and boiler system installation, comprising:
(a) providing a processing unit,
(b) providing said processing unit having a means to store and execute instructions,
(c) providing said processing unit having a means to store and manipulate data,
(d) providing a set of data representing the operational efficiency of a plurality of available furnace, heater, and boiler systems,
(e) providing a set of data representing the fuel cost for a plurality of available furnace, heater, and boiler systems,
(f) providing a set of data representing the relative heat content for a plurality of available fuel sources, and
(d) a set of instructions having a means to:
(i) access the said sets of data,
(ii) calculate the operational cost efficiency of each available furnace, heater, and boiler system,
(iii) compare the relative operational cost efficiency of each available furnace, heater, and boiler system, and
(iv) signal the most advantageous choice of available furnace, heater, and boiler systems,
whereby the optimal operational cost efficiency of the hybrid installation is determined.

2) The method of claim 1 further including:
(a) providing a set of data representing the exterior-temperature-dependent operational efficiency of an available furnace, heater, or boiler system, and
(b) providing data representing the current exterior temperature.

3) The method of claim 2 further including:
(a) providing a set of data representing the solar energy-dependent operational efficiency of an available furnace, heater, or boiler system, and
(b) providing data representing the current solar energy.

4) The method of claim 1 further including:
(a) providing a set of data representing the solar energy-dependent operational efficiency of an available furnace, heater, or boiler system, and
(b) providing data representing the current solar energy.

5) An apparatus for centrally controlling a hybrid furnace, heater, and boiler system installation, comprising:
(a) a processing unit,
(b) said processing unit having a means to store and execute instructions,
(c) said processing unit having a means to store, manipulate and communicate data,
(d) a power supply,
(e) said power supply having a means of delivering necessary power to operate said apparatus,
(f) a data interface,
(g) said data interface having a means of communicating data to and from an external data source,
(h) said data interface having a means of communicating data representing the operational efficiency of a plurality of available furnace, heater, and boiler systems,
(i) said data interface having a means of communicating data representing the fuel cost for a plurality of available fuel sources,
(j) a set of data representing the relative heat content for a plurality of available fuel sources,
(k) a plurality of output driver circuits,
(l) said output driver circuits having a means of activating and de-activating external furnace, heater, or boiler systems, and
(m) a set of instructions having a means to:
(i) access the said sets of data,
(ii) calculate the operational cost efficiency of each available furnace, heater, and boiler system,
(iii) compare the relative operational cost efficiency of each available furnace, heater, and boiler system, and
(iv) signal the most advantageous choice of available furnace, heater, and boiler systems,
whereby the overall operational cost efficiency of the hybrid installation is increased.

6) The apparatus of claim 5 further including:
(a) said data interface having a means of communicating a set of data representing time-dependent fuel costs for a plurality of available fuel sources,
(b) a real-time clock, and
(c) said real-time clock having a means of communicating data representing the current time.

7) The apparatus of claim 6 further including:
(a) said data interface having a means of communicating a set of data representing the desired temperature of the heated environment,
(b) an interior temperature sensor within the heated environment,
(c) said interior temperature sensor having a means to communicate a set of data representing the temperature within the heated environment, and
(d) a set of instructions having a means to thermostatically control the hybrid furnace, heater, and boiler system installation based upon the temperature of the environment being heated.

8) The apparatus of claim 7 further including:
(a) a set of data representing the exterior-temperature-dependent operational efficiency of one or more available furnace, heater, or boiler systems,
(b) an exterior temperature sensor outside the heated environment, and
(c) said exterior temperature sensor having a means to communicate a set of data representing the current exterior temperature.

9) The apparatus of claim 8 further including:
(a) a set of data representing the solar energy-dependent operational efficiency of one or more available furnace, heater, or boiler systems,
(b) a solar energy sensor, and
(c) said solar energy sensor having a means to communicate a set of data representing the current solar energy.

10) The apparatus of claim 7 further including:
(a) a set of data representing the solar energy-dependent operational efficiency of one or more available furnace, heater, or boiler systems,
(b) a solar energy sensor, and
(c) said solar energy sensor having a means to communicate a set of data representing the current solar energy.

11) The apparatus of claim 6 further including:
a) a set of data representing the exterior-temperature-dependent operational efficiency of one or more available furnace, heater, or boiler systems,
(b) an exterior temperature sensor outside the heated environment, and
(c) said exterior temperature sensor having a means to communicate a set of data representing the current exterior temperature.

12) The apparatus of claim 11 further including:
(a) a set of data representing the solar energy-dependent operational efficiency of one or more available furnace, heater, or boiler systems,
(b) a solar energy sensor, and
(c) said solar energy sensor having a means to communicate a set of data representing the current solar energy.

13) The apparatus of claim 6 further including:
(a) a set of data representing the solar energy-dependent operational efficiency of one or more available furnace, heater, or boiler systems,
(b) a solar energy sensor, and
(c) said solar energy sensor having a means to communicate a set of data representing the current solar energy.

14) The apparatus of claim 5 further including:
(a) said data interface having a means of communicating data representing the desired temperature of the heated environment,
(b) an interior temperature sensor within the heated environment,
(c) said interior temperature sensor having a means to communicate a set of data representing the temperature within the heated environment, and
(d) a set of instructions having a means to thermostatically control the hybrid furnace, heater, and boiler system installation based upon the temperature of the environment being heated.

15) The apparatus of claim 14 further including:
(a) a set of data representing the exterior-temperature-dependent operational efficiency of one or more available furnace, heater, or boiler systems,
(b) an exterior temperature sensor outside the heated environment, and
(c) said exterior temperature sensor having a means to communicate a set of data representing the current exterior temperature.

16) The apparatus of claim 15 further including:
(a) a set of data representing the solar energy-dependent operational efficiency of one or more available furnace, heater, or boiler systems,
(b) a solar energy sensor, and
(c) said solar energy sensor having a means to communicate a set of data representing the current solar energy.

17) The apparatus of claim 14 further including:
(a) a set of data representing the solar energy-dependent operational efficiency of one or more available furnace, heater, or boiler systems,
(b) a solar energy sensor, and
(c) said solar energy sensor having a means to communicate a set of data representing the current solar energy.

18) The apparatus of claim 5 further including:
(a) a set of data representing the exterior-temperature-dependent operational efficiency of one or more available furnace, heater, or boiler systems,
(b) an exterior temperature sensor outside the heated environment, and
(c) said exterior temperature sensor having a means to communicate a set of data representing the current exterior temperature.

19) The apparatus of claim 18 further including:
(a) a set of data representing the solar energy-dependent operational efficiency of one or more available furnace, heater, or boiler systems,
(b) a solar energy sensor, and
(c) said solar energy sensor having a means to communicate a set of data representing the current solar energy.

20) The apparatus of claim 5 further including:
(a) a set of data representing the solar energy-dependent operational efficiency of one or more available furnace, heater, or boiler systems,
(b) a solar energy sensor, and
(c) said solar energy sensor having a means to communicate a set of data representing the current solar energy.
